(19) United States
(12) Patent Application Publication
(10) Pub. No.: US 2013/0046934 A1
(43) Pub. Date: Feb. 21, 2013

(54) SYSTEM CACHING USING HETEROGENOUS MEMORIES

(71) Applicants: Robert Nychka, Canton, TX (US); William Michael Johnson, Austin, TX (US); Steven D. Krueger, Dallas, TX (US)

(72) Inventors: Robert Nychka, Canton, TX (US); William Michael Johnson, Austin, TX (US); Steven D. Krueger, Dallas, TX (US)

(21) Appl. No.: 13/209,439

(22) Filed: Aug. 15, 2011

(51) Int. Cl. G06F 12/08

(52) U.S. Cl. 711/119; 711/118; 711/E12.023; 711/E12.017

(57) ABSTRACT

A caching circuit includes tag memories for storing tagged addresses of a first cache. On-chip data memories are arranged in the same die as the tag memories, and the on-chip data memories form a first sub-hierarchy of the first cache. Off-chip data memories are arranged in a different die as the tag memories, and the off-chip data memories form a second sub-hierarchy of the first cache. Sources (such as processors) are arranged to use the tag memories to service first cache requests using the first and second sub-hierarchies of the first cache.

### BACKGROUND

Historically, the performance of computer systems has been directly linked to the time a processor takes to access data from memory. To reduce memory access times, cache memories have been developed for storing frequently used information. A cache is a relatively small, high-speed memory that is used to hold the data contents of the most recently used blocks of main storage. When a processor issues a read instruction, the cache checks its contents to determine if the data is present in the cache contents. If the data is already present in the cache (termed a “hit”), the data is forwarded to the processor with practically no wait. If, however, the data is not present (termed a “miss”), the cache then retrieves the data from a slower, secondary memory source, such as the main memory or a lower level cache. However, in multilevel cache systems longer latencies are typically incurred when a miss occurs due to the time it takes to provide new data from lower levels of the multilevel hierarchy.

### SUMMARY

The problems noted above are solved in large part by using different memory technologies to form different sub-hierarchies within a single-level cache that has a tag memory that is arranged to store tags (that can be different sizes for each sub-hierarchy) for the memory formed using different memory technologies. As disclosed herein, a caching circuit includes tag memories for storing tagged addresses of a first cache. On-chip data memories are arranged in the same die as the tag memories, and the on-chip data memories form a first sub-hierarchy of the first cache. Off-chip data memories are arranged in a different die as the tag memories, and the off-chip data memories form a second sub-hierarchy of the first cache. Sources (such as processors) are arranged to use the tag memories to service first cache requests using the first and second sub-hierarchies of the first cache

### BRIEF DESCRIPTION OF THE DRAWINGS

Particular embodiments in accordance with the invention will now be described, by way of example only, and with reference to the accompanying drawings:

FIG. 1 shows an illustrative computing device 100 in accordance with embodiments of the disclosure.

FIG. 2 is a schematic diagram illustrating a parametric caching system in accordance with embodiments of the disclosure.

FIG. 3 is a schematic diagram illustrating of tag allocation of a parametric caching system in accordance with embodiments of the disclosure.

FIG. 4 is a block diagram illustrating a physical memory map for a cache of a parametric caching system in accordance with embodiments of the disclosure.

FIG. 5 is a block diagram illustrating a quality of service table of a parametric caching system in accordance with embodiments of the disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and appended claims to refer to particular system components. As one skilled in the art will appreciate, various names can be used to refer to a component. Accordingly, distinctions are not necessarily made herein between components that differ in name but not function. In the following discussion and in the claims, the terms “including” and “comprising” are used in an open-ended fashion, and thus are to be interpreted to mean “including, but not limited to . . . ” Further, the meaning of the term “or” (as an inclusive or an exclusive “or”) is determined by the surrounding context in which the term is used. Also, the terms “coupled to” and/or “couples with” and/or “applied to” (and the like) are intended to describe either an indirect or direct electrical connection. Thus, if a first device couples to a second device, that connection can be through a direct electrical connection, or through an indirect electrical connection via other devices and connections. The term “circuit switched” does not require actual switching of the circuit: it merely implies that a given communication link is connected, at least for a period of time, between two nodes for the purpose of transmitting a continuous stream of data. “Associated” means a controlling relationship, such as a memory resource that is controlled by an associated port. While the invention has been described with reference to illustrative embodiments, this description is not intended to be construed in a limiting sense.

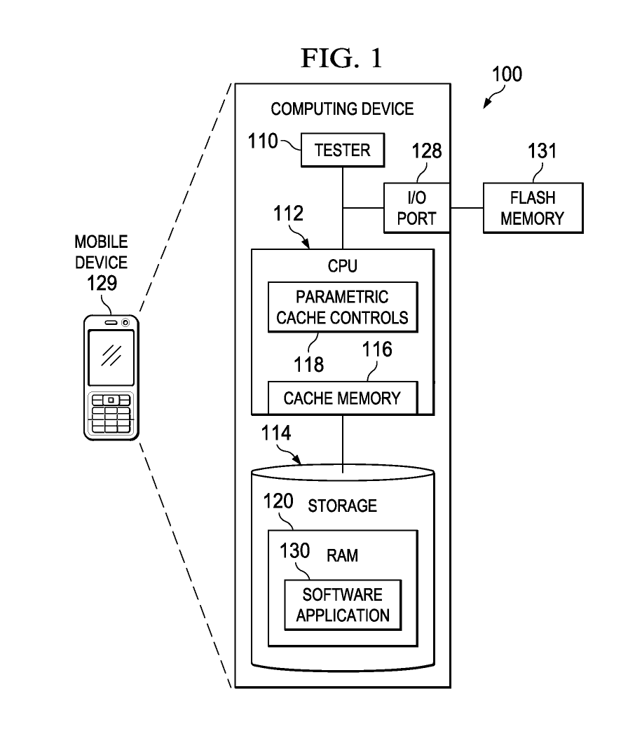

FIG. 1 shows an illustrative computing device 100 in accordance with embodiments of the disclosure. The computing device 100 is, or is incorporated into, an electronic device 129, such as a cell-phone, a camera, a portable media player, a personal digital assistant (e.g., a BLACKBERRY® device), a personal computer, automotive electronics, or any other type of electronic system.

In some embodiments, the computing device 100 comprises a megacell or a system-on-chip (SoC) and is often implemented using an Application Specific Integrated Circuit (ASIC). The computing device 100 includes control logic such as a CPU 112 (Central Processing Unit), a storage 114 (e.g., random access memory (RAM)) and tester 110. The CPU 112 can be, for example, a CISC-type (Complex Instruction Set Computer) CPU, RISC-type CPU (Reduced Instruction Set Computer), or a digital signal processor (DSP). The storage 114 (which can be memory such as RAM 120, flash memory, or disk storage) stores one or more software applications 130 (e.g., embedded applications) that, when executed by the CPU 112, perform any suitable function associated with the computing device 100. The tester 110 comprises logic that supports testing and debugging of the computing device 100 executing the software application 130. For example, the tester 110 can be used to emulate a defective or unavailable component(s) of the computing device 100 to allow verification of how the component(s), were it actually present on the computing device 100, would perform in various situations (e.g., how the component(s) would interact with the software application 130). In this way, the software application 130 can be debugged in an environment which resembles post-production operation.

The CPU 112 typically comprises memory (including flash memory) and logic which store information frequently accessed from the storage 114. The CPU 112 is arranged to control and/or implement the functions of the cache memory 116 and the parametric cache controls 118, which are used during the execution the software application 130. Portions of the parametric cache controls 118 can be distributed amongst other components of the computing device 100 and/or the cache memory 116. The CPU 112 is coupled to I/O (Input-Output) port 128, which provides an interface (that is configured to receive input from (and/or provide output to) peripherals and/or computing devices, including tangible media (such as the flash memory 131) and/or cabled or wireless media (such as a Joint Test Action Group (JTAG) interface).

Most cache memories have a similar physical structure and generally have two major subsystems: a tag subsystem (also referred to as a cache tag array) and memory subsystem (also known as cache data array). The tag subsystem holds address information and determines whether there is a match for a requested data address, and the memory subsystem stores and delivers the addressed data upon request. Thus, each tag entry is typically associated with a data array entry, where each tag entry stores a portion of the address associated with each data array entry. Some data processing systems have several cache memories in a multi-level cache hierarchy, in which case each data array of each level includes a corresponding tag array to store addresses.

To help speed memory access operations, cache designs rely upon principles of temporal and spatial locality. These principles of locality are based on the assumption that, in general, a computer program most often accesses only a relatively small portion of the information available in computer memory in a given period of time. More specifically, the principle of temporal locality holds that if some information is accessed once, it is likely to be accessed again soon, whereas the principle of spatial locality holds that if one memory location is accessed then other nearby memory locations are also likely to be accessed. Thus, in order to exploit temporal locality, caches are used to temporarily store information read from a slower-level memory the first time it is accessed so that if the requested data is soon accessed again the requested data need not be retrieved from the slower-level memory. To exploit spatial locality, cache designs transfer several blocks of data from contiguous addresses in slower-level memory, in addition to the requested block of data, each time data is written in the cache from slower-level memory.

Multi-level cache memory hierarchies are used to generally improve the proficiency of a central processing unit. In a multi-level cache infrastructure, a series of caches L1, L2, L3 or more can be linked together, where each cache is accessed serially by the microprocessor. For example, in a three-level cache system, the microprocessor will first access the fast L1 cache for data, and in case of a miss, it will access slower cache L2. If the L2 cache does not contain the data, the microprocessor will access the slower but larger L3 cache before accessing the (slower) main memory. Because caches are typically smaller and faster than the main memory, a general design trend is to design computer systems using a multi-level cache hierarchy.

As disclosed herein, a cache system receives data for caching and selectively caches the received data in memory by evaluating a system parameter and selecting one from at least two memory types (e.g., the technologies used to implement the memory) in which to cache the data having differing operational parameters in response to the evaluation of the system parameter. Each memory type used for the cache typically has different memory capacities and is organized logically as being the same level of cache. Accordingly, the cache includes cache memory having fixed or selected tag entry widths where each memory type has a tag entry width suitable for the size of the memory type and the number of “ways” of the memory type. Scratchpad memory in the cache can be use to store the system parameters that are used to describe the quality of service of each memory type. The quality-of-service (QoS) parameters define parameters such as cost per bit, speed of access, power consumption, bandwidth, and the like. The scratchpad memory can also be used to associate a particular address with the memory type selected for that address. A second cache can be coupled to the first cache using through-silicon vias.

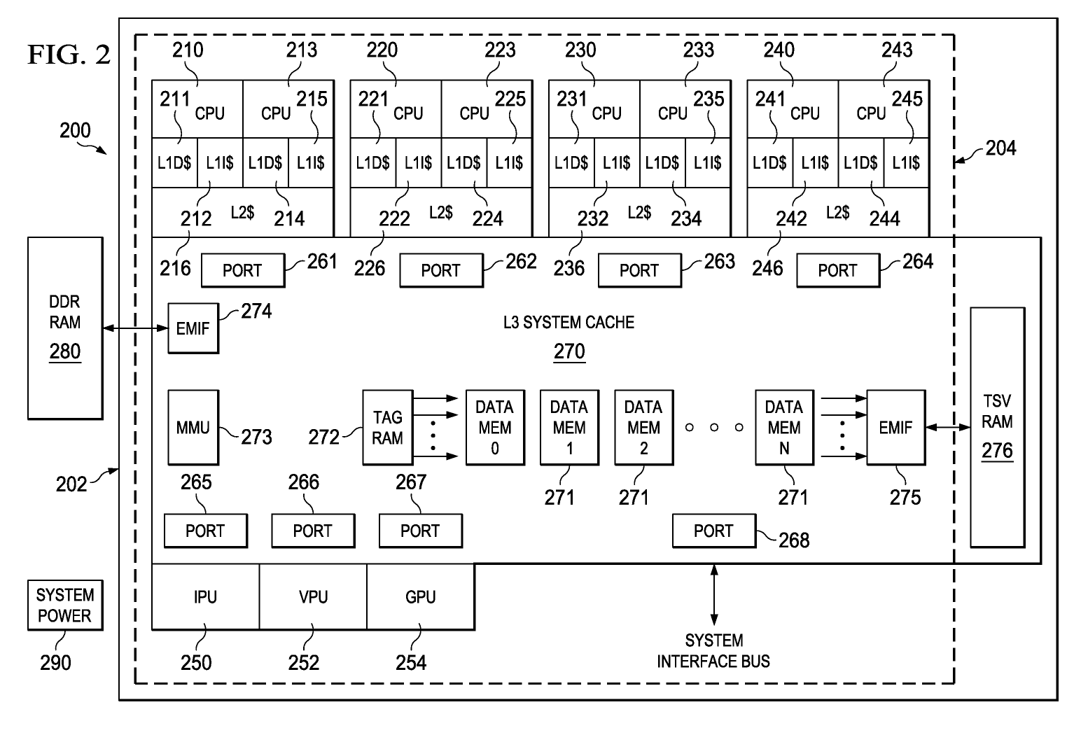

FIG. 2 is a schematic diagram illustrating a parametric caching system in accordance with embodiments of the disclosure. Computing system 200 is illustrated as including a common substrate 202 upon which the illustrated elements of the computing system 200 are formed. The common substrate 202 also includes chip-to-chip mounting technologies. For example, TSV (Through-Silicon-Via) RAM 276 can be an SDR-(single date rate-) or a DDR-(double data rate-) type RAM that is “stacked” upon substrate 204 (which is illustrated as having at least portions of the included structures being formed within a common die). Forming and/or assembling the illustrated elements of the computing system 200 on the common substrate 202, for example, provides increased integration and reduces the number of connections for which drivers, bonding pads, and wiring would otherwise be used. In various embodiments, the elements illustrated as being formed in substrate 202 are optionally included in separate circuit boards and packages (such as the TSV RAM 276).

System power 290 is used to power both the elements of substrate 202 and DDR RAM 280; although the DDR RAM 280 can be partially or completely powered by another power supply. System power 290 is a fixed or controllable (including programmable) power supply and is used, for example, to generate voltages for both reduced (e.g., for conserving power) and normal operation (e.g., for faster speeds) modes of operation for the processors included in substrate 202.

The substrate 204 includes processors 210, 220, 230, 240, 243, 250, 252, and 254, with each processor also being a processing system in its own right. Each processor is a DSP, CPU, controller, microprocessor, or the like, and is used to provide processing power for computer system 200. CPUs 210 and 213 each include an L1 data cache (211 and 214, respectively) and an L1 instruction cache (212 and 215, respectively) and share a common L2 cache 216. CPUs 220 and 223 each include an L1 data cache (221 and 224, respectively) and an L1 instruction cache (222 and 225, respectively) and share a common L2 cache 226. CPUs 230 and 233 each include an L1 data cache (231 and 234, respectively) and an L1 instruction cache (232 and 235, respectively) and share a common L2 cache 236. Likewise, CPUs 240 and 243 each include an L1 data cache (241 and 244, respectively) and an L1 instruction cache (242 and 245, respectively) and share a common L2 cache 246. Processors IPU (image processing unit) 250, VPU (video processing unit) 252, and GPU (graphics processing unit 254) optionally have local caches and are interfaced to L3 cache 270.

L3 cache 270 includes series of ports that provide interfaces for the processors. For example, port 261 interfaces with CPUs 210 and 213, port 262 interfaces with CPUs 220 and 213, port 263 interfaces with CPUs 230 and 233, port 264 interfaces with CPUs 240 and 243, port 265 interfaces with IPU 250, port 266 interfaces with VPU 252, port 267 interfaces with IPU 254, and port 268 provides an interface for a system interface bus. (The system interface bus is used for purposes such as debugging, communicating with user interface or other external devices, and the like.) Each port can be shared with any processor in accordance with bandwidth, traffic, speed, and other considerations. Certain ports are optimized for memory accesses from specific processors (while retaining the ability to handle communications from other processors).

Extended memory interfaces (EMIFs) are provided for interfacing both off-substrate (e.g., with respect to substrate 202) and on-substrate memory with the L3 cache 270. EMIF 274 is used to interface (for example) DDR RAM 280 with the L3 cache 270. DDR RAM 280 is typically bigger and slower than memory technologies used in either the original die-portion of the L3 cache 270 or the TSV RAM 276 (that is arranged in the common substrate 202 with the L3 cache 270 using, for example, a TSV-type, on-substrate, die-to-die mounting). EMIF 275 is used to provide an interface to the memory used in the original die-portion of the L3 cache 270 is typically faster and smaller than either the memory in the TSV RAM 276 or the DDR RAM 280. The TSV RAM 276 is logically organized as part of the L3 cache 270 (e.g., because it is tagged by tag RAM 272): even when different technologies are used to implement memory used in the original die-portion of the L3 cache 270 and the TSV RAM 276.

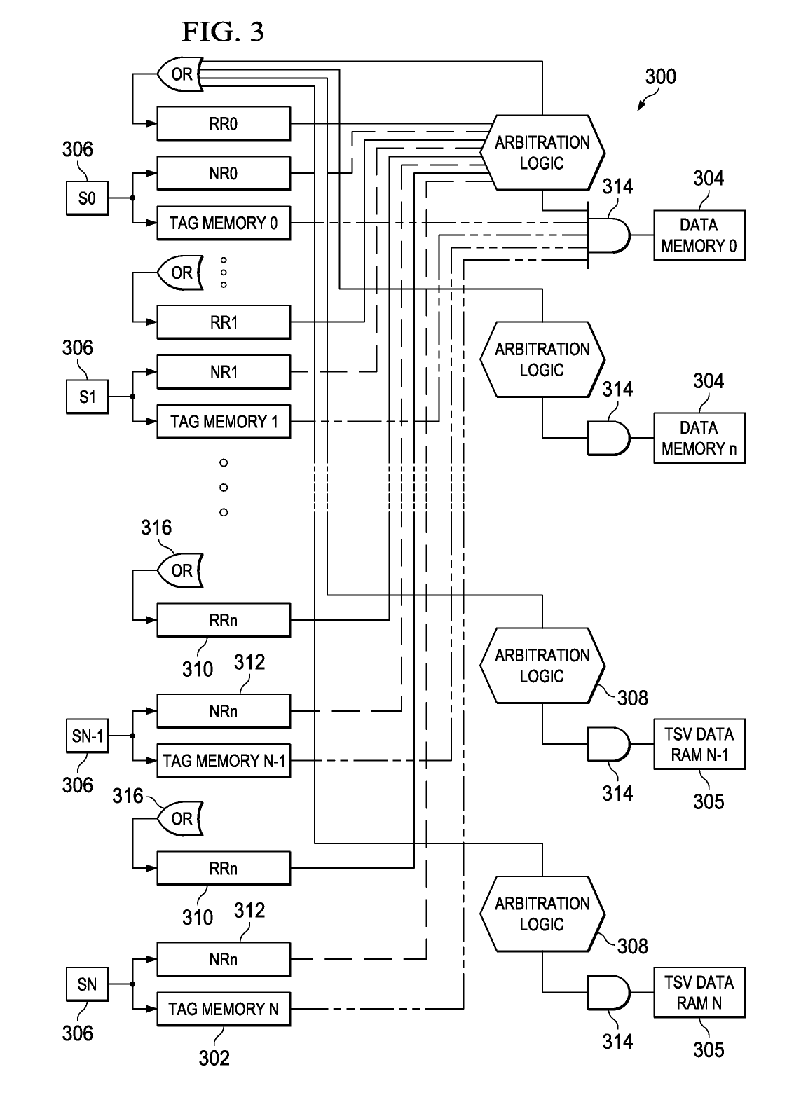

L3 cache 270 includes banks of data memories 271 for caching data. MMU (memory management unit) 273 is a cache controller arranged to control how data is cached within the L3 cache 270. For example, MMU 273 accesses the tag RAM 272 to determine whether a memory access is cached in the L3 cache. When the tag RAM 272 contains a tag for the requested data (e.g., by including a tag pointing to either to a cache line in a data memory bank 271 or in TSV RAM 278), a “hit” occurs, and the data associated with the memory access is either read from or written to the L3 cache 270 as appropriate. When the tag RAM 272 does not contain a tag for the requested data, a “miss” occurs, and the L3 cache 270 caches the data (as described with reference to FIG. 3 below).

To minimize latencies associated with accessing main memory, a speculative access of a main memory is performed. A speculative access of main memory is initiated in response to a cache request and occurs in parallel with tag lookup initiated in response to the cache request. The speculative access of the main memory is cancelled in response to a cache hit determined by the tag lookup initiated in response to the cache request. Accordingly, searching the L3 cache 270 does not introduce substantial delays when retrieving data from main memory that has not been cached in L3 cache 270.

A second cache (that is similar to L3 cache 270) can be coupled to the L3 cache 270 using through-silicon vias. An integrated snooping directory with policy data ensures coherency between all sources where a policy with data indicates that if a cache line is dirty in a sub-hierarchy of a cache, a snoop operation is performed to recover most recent data for the cache line. Dirty line entries of the tag memories can be cleaned incrementally when a status indication of a main memory (such as DDR RAM 280) that is not coupled to the L3 cache 270 using through-silicon vias indicates the main memory is in an idle state.

FIG. 3 is a schematic diagram illustrating of tag allocation of a parametric caching system in accordance with embodiments of the disclosure. Sources 306 use the tag memories 302 with the data memories 304 as a cache 300. The sources 306 can be any hardware or software that requests data. For example, a source 306 can be a processor, a bus, a program, etc. A cache comprises a database of entries. Each entry has data that is associated with (e.g. a copy of) data in main memory. The data is stored in a data memory 304 of the cache 300. Each entry also has a tag, which is associated with (e.g. identifies) the address used to store the data in the main memory. The tag is stored in the tag memories 302 of the cache. When a source 306 requests access to data, the cache 300 is checked first via a cache request because the cache 300 provides faster access to the data than main memory. If an entry can be found with a tag matching the address of the requested data, the data from the data memory of the cache entry is accessed instead of the data in the main memory (“cache hit”). The percentage of requests that result in cache hits is often referred to as the hit rate or hit ratio of the cache. When the cache 300 does not contain the requested data, the situation is a cache miss. Cache hits are preferable to cache misses because hits involve less time and resources than cache misses.

In at least one embodiment, each source 306 uses a separate tag memory 302. For example, source 0 (“S0”) uses tag memory 0, source 1 (“S1”) uses only tag memory 1, source N-1 (“SN-1”) uses only tag memory N-1, and source N-1 (“SN”) uses only tag memory N. Also, each source 306 is configured to use each data memory (304) or TSV data RAM (305) in at least one embodiment. For example, source S0 is configured to use data memory 0, data memory 1, and the like including TSV data RAM 0 and TSV data RAM N; S1 is configured to use data memory 0, data memory 1, and the like including TSV data RAM 0 and TSV data RAM N; and so forth. As such, each individual tag memory, e.g. tag memory 0, can refer to data in any data memory or TSV data RAM. Accordingly, each tag memory 302 is updated such that each of the tag memories 302 comprises identical contents (although the size of individual tags can differ for entries for the data memories and the entries for the TSV data RAM). Updating the tag memories 302 preserves the association between tags in the tag memories 302 and the data in the data memories 304. For example, if tag memory 1 changes contents due to data memory 0 changing contents, then all other tag memories 302 are updated to reflect the change in tag memory 1.

In some embodiments, the system 300 can be configured to operate using any number of data memories. For example, the system 300 can be configured to operate as a cache with two data memories 304 and two TSV data RAMs 305. The system 300 may then be reconfigured to operate as a cache with twenty data memories 304 and/or TSV data RAMs 305. In at least one embodiment, either 1, 2, 3, 4, 5, 6, 7, 8, 9, 10, 11, 12, 13, 14, 15, or 16 data memories 304 and/or TSV data RAMs 305 are used.

Main memory can be divided into cache pages, where the size of each page is equal to the size of the cache. Accordingly, each line of main memory corresponds to a line in the cache, and each line in the cache corresponds to as many lines in the main memory as there are cache pages. Hence, two pieces of data corresponding to the same line in the cache cannot both be stored simultaneously in the cache. Such a situation can be remedied by limiting page size, but results in a tradeoff in increased resources necessary to determine a cache hit or miss. For example, if each page size is limited to the size of half the cache, then two lines of cache must be checked for a cache hit or miss, one line in each “way,” or number of pages in the whole cache. For example the system 300 can be configured to operate as a cache using two ways, by checking two lines for a cache hit or miss. The system 300 can then be reconfigured to operate as a cache using nine ways, by checking nine lines for a cache hit or miss. In at least one embodiment, the system 300 is configured to operate using any number of ways. In at least one embodiment 2, 3, 4, 5, 6, 7, or 8 ways are used.

Larger caches have better hit rates but longer latencies than smaller caches. To address this tradeoff, many computers use multiple levels of cache, with small fast caches backed up by larger slower caches. A cache that is accessed first to determine whether the cache system hits or misses is a level 1 cache. A cache that is accessed second, after a level 1 cache is accessed, to determine whether the cache system hits or misses is a level 2 cache. In at least one embodiment, the system 300 is configured to operate as a level 1 cache and a level 2 cache. For example, the system 100 may be configured to operate as a level 1 cache. The system 300 may then be reconfigured to operate as a level 2 cache.

In at least one embodiment, the system 300 comprises separate arbitration logic 308 for each of the data memories 304. Arbitration logic 308 determines the order in which cache requests are processed. The cache request that “wins” the arbitration accesses the data memories 304 first, and the cache requests that “lose” are “replayed,” by being arbitrated again without the winner. A cache request “loss” is an arbitration miss. Preferably, arbitration is replayed, based on an arbitration miss and way hit, without accessing the tag memories 302. As such, the tag memories 302 are free to be accessed based on other cache requests at the time the tag memory would have been accessed if the tag memory was accessed for replay based on the arbitration miss. Also, the hits and misses generated from one source 306 do not block hits and misses from another source 306. In at least one embodiment, the system comprises replay registers 310, each replay register 310 paired with a tag memory 302. The replay registers 310 allow arbitration replay to bypass the tag memory paired with the replay register, and each replay register receives as input a signal indicating an arbitration miss by each set of arbitration logic 308. A logical OR 316 preferably combines the signals from each set of arbitration logic 308 for each replay register 310. Preferably, arbitration occurs prior to way calculation by way calculation logic 314, and arbitration assumes a tag hit. Way calculation, e.g., checking each way for a hit or miss, preferably occurs after arbitration and the data memories 304 are not accessed on a miss. Arbitration is not replayed if all ways in the tag memory lookup miss.

In at least one embodiment, the system 300 comprises next registers 312. Each next register 312 is paired with a separate tag memory 302. The next registers 312 forward cache requests to the arbitration logic 308 such that the arbitration occurs in parallel with tag lookup in a tag memory 302 paired with the next register 312. As such, the tag output of the tag memory is used only during way calculation by the way calculation logic 314.

For clarity, some of the lines in FIG. 3 have been omitted. For example, the inputs to the arbitration logic 308 coupled to data memory 0 is shown, while others are omitted. The inputs for the each arbitration logic 308 coupled to the data memories 304 and the TSV data RAMs 305 are substantially similar. Only the inputs for the way selection logic 314 coupled to data memory 0 are shown. The inputs for the way selection logic 314 coupled to data memory 1 and TSV data RAMs n-1 and TSV data RAM n are similar coupled except that each way selection logic 314 is coupled to unique arbitration logic. The inputs for the logical OR 316 coupled to RR0 are shown. The inputs for the logical OR gates coupled to RR1 and RRn are substantially similar.

Preferably, the data memories 304 are organized as a banked data array. As such, the least significant bit determines priority, a smaller number given preference over a larger number. Consequently, the number of bank conflicts is reduced. A bank conflict occurs when accesses to the same data memory 304 occurs simultaneously.

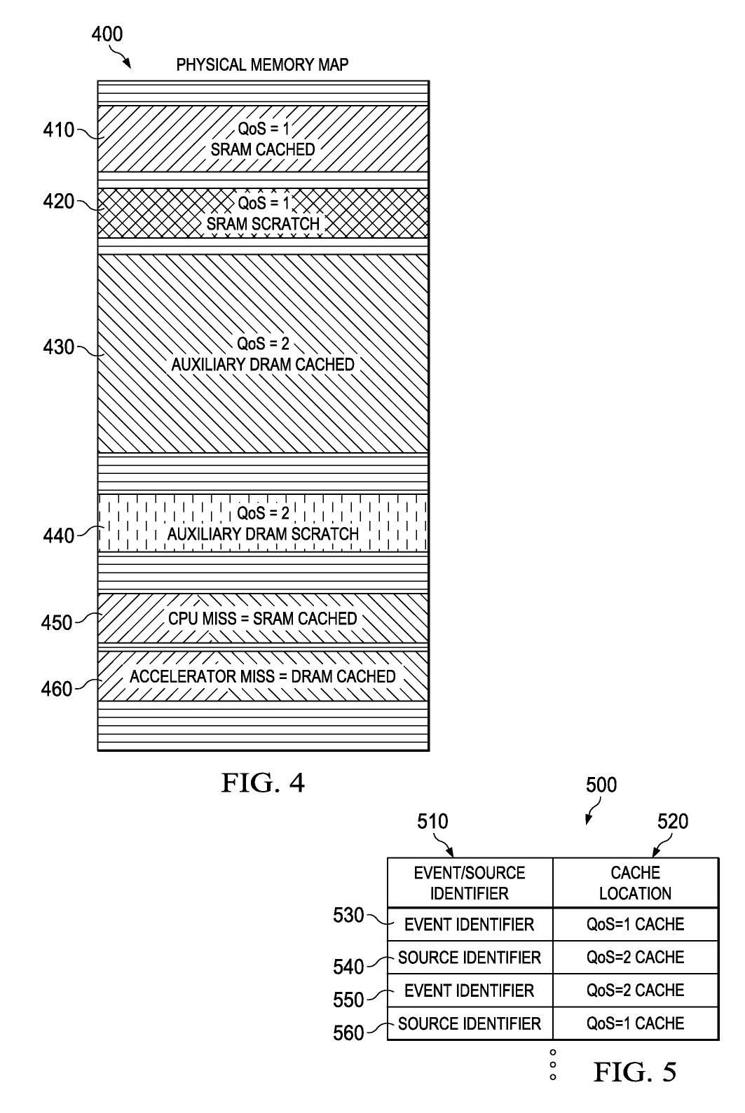

FIG. 4 is a block diagram illustrating a physical memory map for a cache of a parametric caching system in accordance with embodiments of the disclosure. Map 400 illustrates regions of memory in a cache (such as the L3 cache 270 discussed above). Each region typically varies in terms of performance and cost and is associated with provided with a particular level of a quality of service (QoS) that is desired for a particular source (such as a processor as described above). Two levels of quality of service are shown, but more levels of quality of service are possible when additional types of technologies (having different performance levels and costs) are implemented within the cache.

For example, region 410 is designated as being reserved for sources having an associated QoS level of 1. Sources having an associated QoS level of 1 thus use region 410 (which is implemented using relatively faster and more expensive and power consuming SRAM) for its cache. Likewise sources having an associated QoS level of 1 use region 420 (also SRAM) as scratchpad memory. Thus, sources having an associated QoS level of 1 are provided with a high quality of service by the SRAM of the cache.

Region 430 is designated as being reserved for sources having an associated QoS level of 2. Sources having an associated QoS level of 2 thus use region 430 (which is implemented using relatively slower and cheaper and less power consuming DRAM) for its cache. Likewise sources having an associated QoS level of 1 use region 440 (also implemented using DRAM) as scratchpad memory. Thus, sources having an associated QoS level of 2 are provided with a lower quality of service by the DRAM of the cache.

Parametric caching is also based on events. Thus parametric caching using events is performed in addition to or in place of parametric caching based on the identity of a source. For example, region 450 (based in SRAM) is used when a processor (e.g., implemented in hardware) “misses” a memory access, and the referenced data is stored in the higher performance region 450. Likewise a cache accelerator (e.g., based in software) is assigned to use region 460 when an accelerator “miss” occurs. Thus, various events can be used as parameters for determining which region of a cache to use to provide a desired QoS level in response to a particular event.

FIG. 5 is a block diagram illustrating a quality of service table of a parametric caching system in accordance with embodiments of the disclosure. Quality of service (QoS) table 500 can be located in memory that is easily accessible by a system memory management unit such as MMU 273 as illustrated in FIG. 2. As such, the QoS table 500 can be located, for example, in dedicated memory in MMU 273 or any of the banks of data memories 271 as scratchpad memory. QoS table 400 is used to store the system parameters that are used to describe the quality of service of each memory type (such as the type of memory used for the banks of data memories 271 and the type of memory used for the TSV RAM 276). The quality-of-service (QoS) parameters define parameters such as cost per bit, speed of access, power consumption, bandwidth, and the like.

QoS table 500 is initialized by a boot kernel with parameters during boot loading and thus the physical memory type can be transparent to a high-level operating system (OS). Entries in the QoS table 500 are used by MMU 273 determine memory type based on initiator ID and the type of memory (such as banks of data memories 271 or TSV RAM 276) to be provided to the initiator.

For example, table 500 is organized using column 510 for storing an identifier used to identify a source that initiates a memory request and/or an event that is associated with the memory request. Column 520 contains an indication for providing a particular QoS level: such as a QoS level of 1 or a QoS level of 2. Thus, an index “lookup” operation is used to determine the appropriate QoS for allocating a particular type of resource for a particular event and/or processor. For example, a memory request from a processor generating a first particular event can be assigned a different QoS level from the same a processor generating a second particular event. In various embodiments, column 520 can include an address (such as a base address) for a particular type of memory that is used to provide a QoS level desired for a particular source and/or event.

Row 530 includes an identifier for an event and provides an indication that points to a portion of the cache that provides of QoS level of 1. Row 540 includes an identifier for a source (such as a particular processor) and provides an indication that points to a portion of the cache that provides of QoS level of 2. Row 550 includes an identifier for an event and provides an indication that points to a portion of the cache that provides of QoS level of 2. Row 560 includes an identifier for a source (such as a particular processor) and provides an indication that points to a portion of the cache that provides of QoS level of 1. More rows can be included as desired for handling various types of events or particular processors.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A circuit for caching, comprising:
tag memories for storing tagged addresses of a first cache;
on-chip data memories arranged in a same die as the tag memories, wherein the on-chip data memories form a first sub-hierarchy of the first cache; and
off-chip data memories arranged in a different die as the tag memories, wherein the off-chip data memories form a second sub-hierarchy of the first cache, wherein sources are arranged to use the tag memories to service first cache requests using the first and second sub-hierarchies of the first cache.

2. The circuit of claim 1, comprising a controller for selecting one of the on-chip data memories and the off-chip data memories for storing data to be cached, wherein the on-chip data memories and the off-chip data memories have a level of service that differ, and wherein the selection is performed in response to a source parameter for specifying a desired level of service for the source.

3. The circuit of claim 1, wherein a speculative access of a main memory is initiated in response to a cache request and occurs in parallel with tag lookup initiated in response to the cache request, and where the speculative access of the main memory is cancelled in response to a cache hit determined by the tag lookup initiated in response to the cache request.

4. The circuit of claim 1, comprising a controller for selecting one of the on-chip data memories and the off-chip data memories for storing data to be cached, wherein the on-chip data memories and the off-chip data memories have a level of service that differ, and wherein the selection is performed in response to a location table stored in a scratchpad area of the on-chip data memories, wherein the location table is indexed using an index that is associated with a desired level of service for the source.

5. The circuit of claim 1, wherein a maintenance activity having an address range having arbitrary start and end addresses performed on the first cache is performed on the first and second sub-hierarchies of the first cache when the first and second sub-hierarchies of the first cache have physical addresses that are included in the address range, wherein the maintenance activity is selected from the group of cleaning, invalidating, and preloading.

6. The circuit of claim 1, wherein dirty line entries of the tag memories are cleaned incrementally when a status indication of a main memory that is not coupled to the first cache using through-silicon vias indicates the main memory is in an idle state.

7. The circuit of claim 1, comprising a controller for selecting one of the on-chip data memories and the off-chip data memories for storing data to be cached, wherein the on-chip data memories and the off-chip data memories have a level of service that differ, wherein the selection is performed in response to a source parameter for specifying a desired level of service for the source, and wherein the controller has an interface port for debugging that permits read or write access to contents of the tag memories, the on-chip data memories and the off-chip data memories.

8. The circuit of claim 1, comprising a controller for maintaining coherency with a second cache that is coupled to the first cache using through-silicon vias.

9. The circuit of claim 1, wherein the on-chip data memories and the off-chip data memories are arranged in a common substrate using through-silicon vias.

10. The circuit of claim 1, wherein the on-chip data memories include static random access memories (SRAMs) and the off-chip data memories include dynamic random access memories (DRAMs).

11. A processing system, comprising:
a processor that is arranged to generate memory requests; and
a cache for storing data associated with the memory requests, wherein the cache includes tag memories for storing tagged addresses of the cache, on-chip data memories arranged in a same die as the tag memories, wherein the on-chip data memories form a first sub-hierarchy of the cache, and off-chip data memories arranged in a different die as the tag memories, wherein the off-chip data memories form a second sub-hierarchy of the cache, wherein sources are arranged to use the tag memories to service cache requests using the first and second sub-hierarchies of the cache.

12. The system of claim 11, comprising a controller for selecting one of the on-chip data memories and the off-chip data memories for storing data to be cached, wherein the on-chip data memories and the off-chip data memories have a level of service that differ, and wherein the selection is performed in response to a source parameter for specifying a desired level of service for the source.

13. The system of claim 12, wherein the source parameter identifies a source of a particular cache source request or an event that is associated with the particular cache source request.

14. The system of claim 13, wherein arbitration of a cache request is replayed, based on an arbitration miss and way hit, without accessing the tag memories.

15. The system of claim 11, wherein a speculative access of a main memory is initiated in response to a cache request and occurs in parallel with tag lookup initiated in response to the cache request, and where the speculative access of the main memory is cancelled in response to a cache hit determined by the tag lookup initiated in response to the cache request.

16. The system of claim 11, comprising a controller for selecting one of the on-chip data memories and the off-chip data memories for storing data to be cached, wherein the on-chip data memories and the off-chip data memories have a level of service that differ, and wherein the selection is performed in response to a location table stored in a scratchpad area of the on-chip data memories, wherein the location table is indexed using an index that is associated with a desired level of service for the source, wherein the location table is loaded by a boot kernel with parameters during boot loading.

17. A method for caching data in memory, comprising:
storing tagged addresses in tag memories of a first cache;
arranging on-chip data memories in a same die as the tag memories, wherein the on-chip data memories form a first sub-hierarchy of the first cache; and
arranging off-chip data memories in a different die as the tag memories, wherein the off-chip data memories form a second sub-hierarchy of the first cache, wherein sources are arranged to use the tag memories to service cache requests using the first and second sub-hierarchies of the first cache.

18. The method of claim 17, comprising coupling a second cache to the first cache using a common substrate.

19. The method of claim 17, comprising selecting one of the on-chip data memories and the off-chip data memories for storing data to be cached, wherein the on-chip data memories and the off-chip data memories have a level of service that differ, and wherein the selection is performed in response to a source parameter for specifying a desired level of service for the source.

20. The method of claim 17, comprising selecting one of the on-chip data memories and the off-chip data memories for storing data to be cached, wherein the on-chip data memories and the off-chip data memories have a level of service that differ, wherein the selection is performed in response to a location table stored in a scratchpad area of the on-chip data memories, and wherein the location table is loaded by a boot kernel with parameters during boot loading.
